(19) United States
(12) Patent Application Publication
(10) Pub. No.: US 2009/0058897 A1
(43) Pub. Date: Mar. 5, 2009

(54) INKJET PRINT HEAD AND INKJET IMAGE FORMING APPARATUS HAVING THE SAME

(75) Inventors: Eun Bong HAN, Suwon-si (KR); Tae Jin Kim, Seongnam-si (KR); Young Hye Park, Yongin-si (KR); Young Ung Ha, Suwon-si (KR); Sung Joon Park, Suwon-si (KR); Nam Kyun Kim, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/196,345

(22) Filed: Aug. 22, 2008

(30) Foreign Application Priority Data
Aug. 24, 2007 (KR) 2007-85245

(51) Int. Cl. B41J 29/38

(52) U.S. Cl. 347/9; 257/288

(57) ABSTRACT

An inkjet print head and an inkjet image forming apparatus having the same includes photo sensors are mounted on the inkjet print head to sense whether or not nozzles normally discharge ink and to sense missing nozzles whenever the ink is printed on a recording paper, thereby rapidly and correctly sensing the missing nozzles.

### CROSS-REFERENCE TO RELATED APPLICATIONS

This application claims priority under 35 U.S.C. §119(a) from Korean Patent Application No. 2007-0085245, filed Aug. 24, 2007, in the Korean Intellectual Property Office, the disclosure of which is incorporated herein by reference.

### BACKGROUND OF THE INVENTION

1. Field of the Invention

The present general inventive concept relates to an inkjet print head and an inkjet image forming apparatus having the same, and more particularly, to an inkjet print head to sense one or more missing nozzles, from which ink is not discharged, and an inkjet image forming apparatus having the inkjet print head.

2. Description of the Related Art

In general, inkjet print heads discharge droplets of ink for printing to desired positions of a printing medium, and thus form an image.

These inkjet print heads are divided into a heat-driven type and a piezoelectric-driven type according to a discharge mechanism of ink droplets. A heat-driven print head generates bubbles in ink using a heat source, and discharges ink droplets by means of the expansion force of the bubbles.

The heat-driven print head generally discharges ink droplets to the outside by means of bubbles obtained by momentarily heating ink, and includes a plurality of ink chambers formed on a substrate, heaters respectively provided in the ink chambers, and nozzles respectively provided above the ink chambers. Thus, the ink stored in the ink chambers is heated by the heaters, and then is discharged to the outside through the nozzles.

In the inkjet print head, when some nozzles out of the plural nozzles are clogged or do not discharge ink due to malfunction of the corresponding heaters or trouble of heater power circuits, white lines are formed on a printing medium and thus causes a poor printing quality.

The above-described nozzles, which are damaged and thus do not discharge ink, are referred to as missing nozzles. It is necessary to sense the missing nozzles and perform printing only using normal nozzles without using the corresponding missing nozzles.

As one example of methods of sensing missing nozzles, Korean Patent Registration No. 10-636236 discloses a method of detecting missing nozzles by scanning a result of printing by a printing unit.

In this method, nozzles discharge ink to a printing medium through nozzles to print a test pattern, and a scan sensor scans the test pattern, thus detecting the missing nozzles.

However, since the test pattern is printed and the missing nozzles are detected through the scan operation, the conventional missing nozzle sensing method has problems, such as a complicated process and a difficulty in rapidly sensing the missing nozzles.

### SUMMARY OF THE INVENTION

The present general inventive concept provides an inkjet print head, which promptly senses missing nozzles by a comparatively simple method when the missing nozzles are generated, and an inkjet image forming apparatus having the inkjet print head.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet print head including one or more nozzle lines provided on a substrate to discharge ink, and a plurality of photo sensors provided on the substrate and separated from the nozzle lines at a designated distance to sense whether or not respective nozzles of the nozzle lines normally discharge the ink.

The foregoing and/or other aspects and utilities of the present general inventive concept may be achieved by providing an inkjet print head including a plurality of heaters provided on a substrate to heat ink, nozzle lines provided on the substrate to discharge the ink, a plurality of photo sensors provided on the substrate and separated from the nozzle lines at a designated distance to sense whether or not respective nozzles of the nozzle lines normally discharge the ink, and logic circuit units provided on the substrate to generate heater control signals to control the plurality of heaters from printing data transmitted from a printer main body to drive the heaters and thus to control the operation of the respective heaters, and to generate photo sensor control signals to sequentially output the output values of the photo sensors from the printing data and thus to control the operation of the respective photo sensors.

The foregoing and/or other aspects and utilities of the present general inventive concept may also be achieved by providing an inkjet image forming apparatus including an inkjet print head including nozzle lines provided on a substrate to discharge ink, a plurality of photo sensors provided on the substrate and separated from the nozzle lines at a designated distance to sense whether or not respective nozzles of the nozzle lines normally discharge the ink, and a photo sensor control logic unit provided on the substrate to sequentially output the output values of the photo sensors, a light source disposed adjacent to the plurality of photo sensors to generate light such that the light is reflected by a recording paper and flows into the plurality of photo sensors, and an ink cartridge main body mounting the inkjet print head and the light source thereon, and moving along the recording paper.

The foregoing and/or other aspects and utilities of the present general inventive concept may also be achieved by providing an inkjet image forming apparatus including an inkjet print head including nozzle lines provided on a substrate to discharge ink, a plurality of photo sensors provided on the substrate and separated from the nozzle lines at a designated distance to sense whether or not respective nozzles normally discharge the ink, and a photo sensor control logic unit provided on the substrate to sequentially output the output values of the photo sensors according to the photo sensor control signal, a light source disposed adjacent to the plurality of photo sensors to generate light such that the light is reflected by a recording paper and flows into the plurality of photo sensors, and a control unit to drive the light source when the inkjet print head moves along the recording paper and determine whether or not the nozzle lines have missing nozzles according to the output values sequentially outputted from the plurality of photo sensors.

The foregoing and/or other aspects and utilities of the present general inventive concept may also be achieved by providing an inkjet print head including one or more plurality of inkjet units to discharge ink, and one or more sensors disposed to sense a state of the inkjet units.

The inkjet print head may further include a main body, and the inkjet units and the sensors may be formed in the main body as a monolithic signal body.

The inkjet print head may further include a logic control unit formed in the main body to control the inkjet units and the sensors.

The inkjet print head may further include a photo sensor control logic unit to control the sensors; and a logic control unit to generate a first signal to control the inkjet units and to generate a second signal to control the photo sensor control logic unit.

The inkjet print head may further include a substrate, and the inkjet units and the sensors are formed on the substrate.

The inkjet units may include one or more nozzles to eject ink on a predetermined position of a recording medium, and e sensors are disposed to detect light from the predetermined position of the recording medium on which the ink is ejected, according to a state of the ejected ink.

The sensors may sense the state of the inkjet units according to the detected light.

The foregoing and/or other aspects and utilities of the present general inventive concept may also be achieved by providing an image forming apparatus including an inkjet print head including one or more plurality of inkjet units to discharge ink, and one or more sensors disposed to sense a state of the inkjet units, and a control unit to generate a signal to control the inkjet units and the sensors to determine the state of the inkjet units.

### BRIEF DESCRIPTION OF THE DRAWINGS

These and/or other aspects and advantages of the present general inventive concept will become apparent and more readily appreciated from the following description of the embodiments, taken in conjunction with the accompanying drawings in which:

FIG. 1 is a view illustrating an inkjet print head in accordance with an embodiment of the present general inventive concept;

FIG. 2 is a cross-sectional view illustrating the inkjet print head of FIG. 1, taken along the line A-A′;

FIG. 3 is a view illustrating arrangement of nozzles and photo sensors of FIG. 1;

FIG. 4 is a cross-sectional view illustrating an internal structure of the photo sensor of FIG. 1;

FIG. 5 is a circuit diagram illustrating a photo sensor control logic unit of the inkjet print head of FIG. 1;

FIG. 6 is a graph illustrating output wave forms SP, SC, and IOUT of FIG. 5;

FIG. 7 is a view illustrating an image forming apparatus to form an image using an ink cartridge having an inkjet print head according to an embodiment of the present general inventive concept;

FIG. 8 is a block diagram illustrating a logic circuit unit provided in an inkjet print head in accordance with the embodiment of the present general inventive concept;

FIG. 9 is a block diagram illustrating a function logic of the control login circuit of FIG. 8; and

FIG. 10 is a timing chart illustrating various signals of FIGS. 8 and 9.

### DETAILED DESCRIPTION OF THE PREFERRED EMBODIMENTS

Reference will now be made in detail to the embodiments of the present general inventive concept, an example of which is illustrated in the accompanying drawings, wherein like reference numerals refer to like elements throughout. The embodiments are described below to explain the present general inventive concept by referring to the annexed drawings.

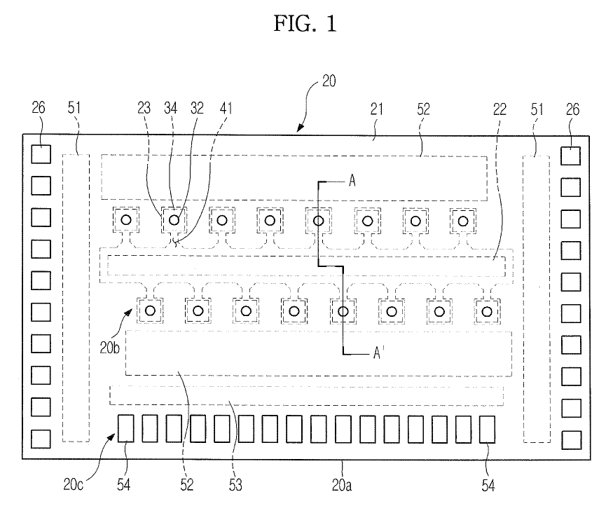

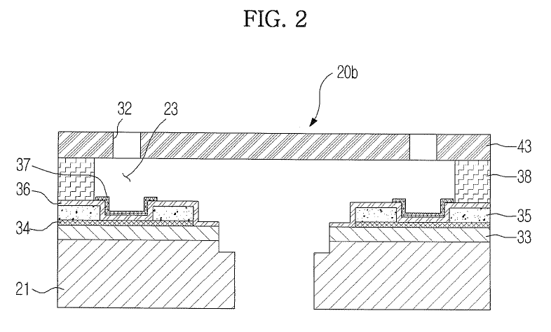

FIG. 1 is a layout illustrating an inkjet print head 20 according to an embodiment of the present general inventive concept, and FIG. 2 is a cross-sectional view illustrating the inkjet print head of FIG. 1, taken along the line A-A′.

The inkjet print head 20 may be a heat-driven inkjet print head, which generates bubbles in ink using a heat source and discharges ink droplets by means of the expansion force of the bubbles. However, the present general inventive concept is not limited thereto. Other type of inkjet print head can be used as the inkjet print head 20. The inkjet print head 20 may include a main body 20a, an inkjet unit (a plurality of inkjet units 20b) formed in a first portion of the main body 20a to eject or discharge ink, and a sensor unit 20c formed in a second portion of the main body 20a to detect a state of discharging ink from the respective inkjet units 20b.

With reference to FIGS. 1 and 2, an ink feed hole 22 is formed through a substrate 21 of the inkjet print head 20 according to the present embodiment. The substrate 21 may be a silicon substrate, which is widely used in manufacturing of an integrated circuit. The ink feed hole 22 is disposed on the lower surface of the substrate 21, and is connected to an ink storage container, which is not shown. The ink feed hole 22 has a rectangular structure.

A plurality of ink chambers 23 are located on an upper surface of the substrate 21 at both sides of the ink feed hole 22. The ink chambers 23 are respectively connected to the ink feed hole 22 through individual channels 41. Ink stored in the ink storage container flows into the substrate 21 through the ink feed hole 22, and is respectively supplied to the plurality of the ink chambers 23 along the individual channels 41. Thus, the ink feed hole 22 serves as a common channel to supply the ink to the individual channels 41.

Further, nozzles 32 are respectively located on the upper surfaces of the ink chambers 23. Therefore, the ink supplied to the ink chambers 23 is discharged to the outside through the nozzles 32. The nozzles 32 are located in a nozzle layer 43. The nozzle layer 43 covers the upper surfaces of the ink feed hole 22, the individual channels 41, and the ink chambers 23.

Heaters 34 serving as ink discharge elements are respectively provided on a bottom surfaces of the ink chambers 23.

Both ends of the heaters 34 are electrically connected to electrodes 35 disposed on the heaters 34. Further, a protection layer 36 covering the heaters 34 and the electrodes 35 is disposed on the upper surfaces of the heaters 34 and the electrodes 35. Thus, the heaters 34 and the electrodes 35 are insulated and protected from the ink by the protection layer 36, and the ink is discharged to the outside by the heating of the heaters 34.

When the ink is discharged to the outside, cavitation occurs in the opposite direction of the ink discharged direction, and may cause physical damage to the protection layer 36 and the heaters 34. Thus, an anti-cavitation layer 37 preventing the physical damage to the protection layer 36 and the heaters 34 due to the cavitation is further disposed on the upper surface of the protection layer 36 located in the ink chambers 23.

A plurality of metal pads 26 is disposed at ends of the inkjet print head 20. The metal pads 26 may be disposed on the same level with the electrodes 35 on the substrate 21. The metal pads 26 electrically connect the inkjet print head 20 and an external circuit, which is not shown.

Further, logic circuit units 51 and power transistor units 52 are disposed on the substrate 21. MOSFETs are located in the logic circuit units 51 to perform addressing and/or decoding operations according to a signal. MOSFETs electrically connected to the heaters 34 are located in the power transistor units 52. These MOSFETs include sources and drains formed in the substrate 21 and gate electrodes located in channels between the sources and drains. The logic circuit units 51 turn on the MOSFETs located in the power transistor units 52 through address lines connected therebetween. Thus, when a specific MOSFET in the power transistor units 52 is turned on by the signal supplied from an external circuit according to the addressing and/or decoding operations, current flows into the heater 34 electrically connected to the MOSFET. Then, the heater 34 is heated to a designated temperature. Therefore, bubbles having a designated size are generated in the corresponding ink chamber 23, and the ink contained in the ink chamber 23 is discharged in the form of ink droplets to the outside through the nozzle 32 due to the bubbles. The addressing and/or decoding operations are operations to designate or drive corresponding heaters 34 to eject or discharge ink through corresponding nozzles 32 according to the signal corresponding to printing data to form an image. The above-described components can be referred to as the inkjet unit 20b.

An insulating layer 33 is interposed between the substrate 21 and the heaters 34. The insulating layer 33 may be a silicon oxidation (SiO2) film.

Photo sensors 54 to sense defects in ink discharge of the nozzles 32 and a photo sensor control logic unit 53 to determine whether or not the corresponding nozzle 32 is a normal nozzle or a missing nozzle through the photo sensors 54 are provided on the substrate 21 as the sensor unit 20c.

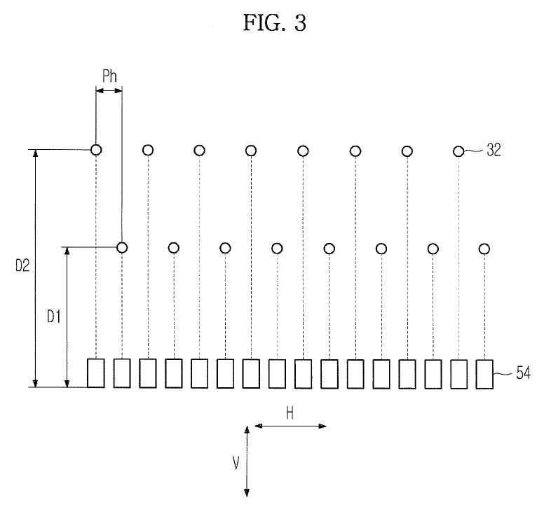

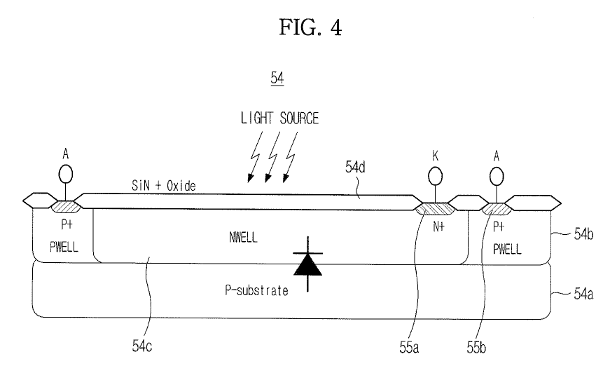

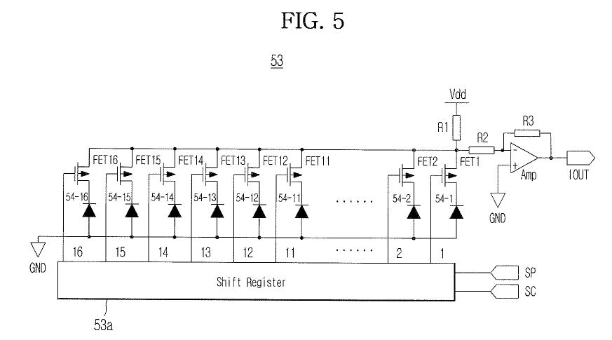

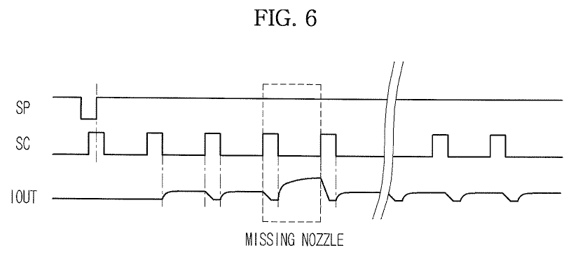

FIG. 3 is a view illustrating the arrangement of the nozzles 32 and the photo sensors 54 of FIG. 1, FIG. 4 is a cross-sectional view illustrating the internal structure of the photo sensor 54 of FIG. 1, FIG. 5 is a circuit diagram illustrating the constitution of the photo sensor control logic unit 53 of FIG. 1, and FIG. 6 is a graph illustrating output wave forms SP, SC, and IOUT of the photo sensor control logic 53 of FIG. 5.

Referring to FIG. 3, the photo sensors 54 are respectively separated from the nozzles 32 forming nozzle lines at a designated distance D1 or D2 vertically on a vertical axis V, and are separated from each other at an interval of a horizontal pitch Ph of the respective nozzles 32 on a horizontal axis H according to resolution between the nozzles 32 so as to correspond to the respective nozzles 32. Thereby, a printing operation is performed to discharge ink through the nozzles 32 to a recording paper to record data (image) onto the paper, and a nozzle detecting operation is performed using the photo sensors 54 disposed at the rear end of the substrate 21 to sense whether or not ink is printed at the positions of the recording paper, corresponding to the nozzles, and/or to determine whether or not the corresponding nozzles are normal nozzles or missing nozzles, simultaneously or respectively.

The above photo sensors 54 may be CMOS photo sensors. By employing the CMOS photo sensors, it is possible to manufacture the photo sensors 54 by the same process as a CMOS process of forming a circuit of the inkjet print head 20 and to mount the photo sensors 54 together with the circuit of the inkjet print head 20. Further, the above photo sensors 54 may be other various sensors.

As illustrated in FIG. 4, each of the photo sensors 54 includes N+ and P+ photoelectric elements 55a and 55b, obtained by doping a support substrate 54a (may be the same substrate as the substrate 21) with impurities at a high concentration by a semiconductor doping process, and P and N semiconductor wells 54b and 54c surrounding the photoelectric elements 55a and 55b to minimize an electrical effect applied from an outside thereof. Each of the photo sensors 54 further includes a protection layer 54d made of, for example, SiN and oxide.

As illustrated in FIG. 5, when a shift start pulse (SP) synchronizing with a shift clock (SC) of a shift register 53a is inputted to the photo sensor control logic unit 53, the photo sensor control logic unit 53 becomes in a standby state, which can output the output values (IOUTs) of the photo sensors 54.

Thereafter, when a next shift clock (SC) is inputted to the photo sensor control logic unit 53, a first MOSFET FET1 is turned on and the remaining MOSFETs FET2-FET16 maintain a turned-off state, and thus the photo sensor control logic unit 53 outputs an output value (IOUT) of the first photo sensor 54-1. Thereafter, when another next shift clock (SC) is inputted to the photo sensor control logic unit 53, the photo sensor control logic unit 53 outputs an output value (IOUT) of the second photo sensor 54-2 while the remaining MOSFETs FET1 and FET3-FET16 are in the turned-off state. By this consecutive method, the photo sensor control logic unit 53 sequentially outputs output values (IOUTs) of the remaining photo sensors 54-3 to 54-16. It is possible to determine whether or not the corresponding nozzle is a normal nozzle or a missing nozzle using the output values (IOUTs) of the photo sensors 54. Further, the position of the missing nozzle is detected by combining the shift clock (SC) and the output value (IOUT) of the photo sensor 54. Resistors R1, R2, and R3, a voltage Vdd, and an amplifier AMP are connected to the MOSFETs.

That is, as illustrated in FIG. 6, in a case that the corresponding nozzle 32 normally discharges ink, the ink is printed on the recording paper at a position corresponding to the nozzle 32 and thus the output value (IOUT) of the corresponding photo sensor 54 sensing the normal discharge of the ink from the nozzle 32 is lower than a predetermined reference value. However, in a case that the corresponding nozzle 32 does not normally discharge ink, the ink is not printed on the recording paper and thus the output value (IOUT) of the corresponding photo sensor 54 sensing the abnormal discharge of the ink from the nozzle 32 is higher than the predetermined reference value. Using such a fact, it is possible to determine whether or not the respective nozzles 32 are normal nozzles or missing nozzles and to detect the position of the missing nozzle 32 by counting the number of the shift clocks (SCs).

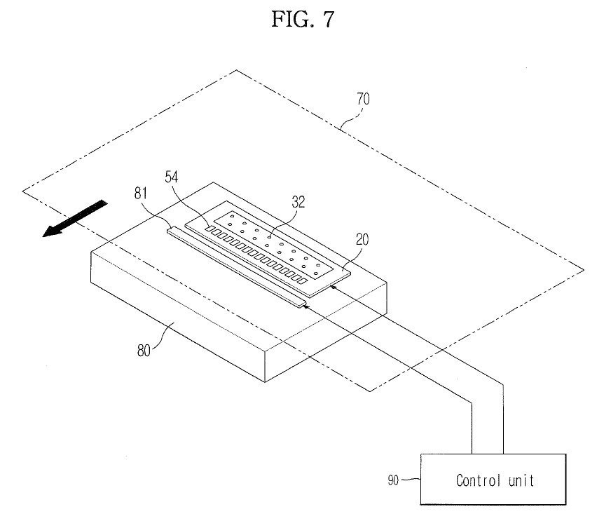

FIG. 7 is a view illustrating an image forming apparatus to print or form an image using an ink cartridge having an inkjet print head according to an embodiment of the present general inventive concept. For convenience of description, this view is turned over, but the ink cartridge is actually located above the upper surface of a printing paper. The image forming apparatus may further include a feeding unit (not illustrated) to feed the recording paper 70 with respect to the ink cartridge main body 80, a discharge unit (not illustrated) to discharge the printed recording paper 70 away from the ink cartridge main body 80.

As illustrated in FIG. 7, an ink cartridge main body 80 having the above-described inkjet print head 20 disposed to face a recording paper 70 and to relatively move with the recording paper in a direction of an arrow. It is possible that the ink cartridge main body 80 reciprocates in a direction perpendicular to the arrow direction to cover a width of the recording paper 70. It is also possible that the ink cartridge main body is a line print head which is in a stationary state not to move the perpendicular direction of the arrow direction.

When the ink cartridge main body 80 moves according to a printing instruction, the nozzle 32 of the inkjet print head 20 discharges ink to print data on the recording paper 70, the photo sensor 54 located at the lower end of the substrate 20 senses a portion of the recording paper 70 printed with the ink, and thus determines whether or not the corresponding nozzle 32 is a normal nozzle or a missing nozzle. A light source 81 is disposed adjacent to or located under the photo sensors 54 such that light generated by the light source 81 is reflected by the recording paper 70 located above the ink cartridge main body 80 and the reflected light is incident into the photo sensors 54, and thus the photo sensors 54 can sense whether or not the ink exists on the positions of the recording paper 70 corresponding to the photo sensors 54 according to the incident light. That is, a control unit 90 drives the light source 81, when the inkjet print head 20 moves along the recording paper 70. The light emitted from the light source 81 is reflected by the recording paper 70, and the photo sensors 54 receive the reflected light. At this time, the normal nozzles 32 normally discharge ink to the corresponding positions of the recording paper 70 and thus light is not incident into the corresponding photo sensors 54, but the missing nozzles 32 do not discharge ink to the corresponding positions of the recording paper 70 and thus light is incident into the corresponding photo sensors 54. It is possible to detect whether or not the nozzles 32 corresponding to the photo sensors 54 are normal nozzles or missing nozzles by checking the output values of the respective photo sensors 54. The control unit 90 determines whether or not there is a missing nozzle in a nozzle line and the position of the missing nozzle according to the output values sequentially outputted from the respective photo sensors 54 using the above method.

The inkjet print head in accordance with this embodiment includes a plurality of photo sensors separated from nozzle lines at a designated distance so as to sense defects in ink discharge of the respective nozzles discharging ink.

In a case that signal lines to control the respective photo sensors and signal lines to control the heaters are separately provided, the total number of the signal lines may be increased and the print head and the main body of the image forming apparatus may have a complicated circuit constitution.

Therefore, it is necessary to simplify the constitution of the inkjet print head and the circuit constitution of the main body of the image forming apparatus by decreasing the number of the metal pads provided on the inkjet print head to receive data from the main body of the image forming apparatus by generating optical sensor control signals to control the plurality of the photo sensors provided on the inkjet print head using printing data transmitted from the main body of the image forming apparatus to the inkjet print head.

For this reason, in the embodiment of the present general inventive concept, a function logic, which generates photo sensor control signals using printing data transmitted from a main body of the image forming apparatus to the inkjet print head, is added to the logic circuit unit 51 provided on the inkjet print head 20.

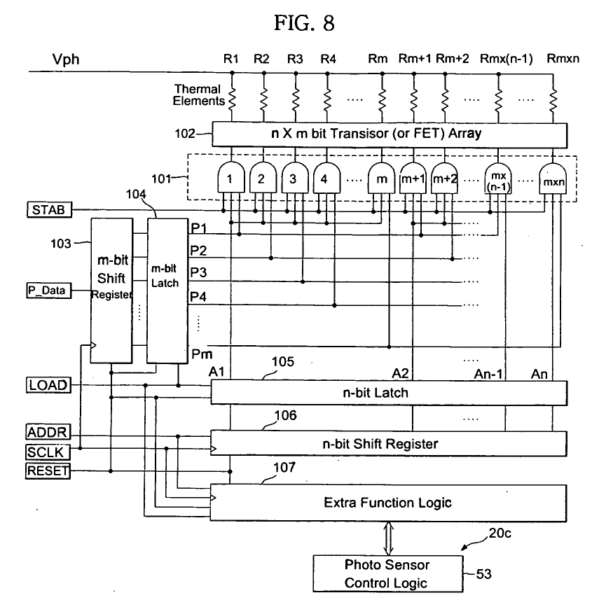

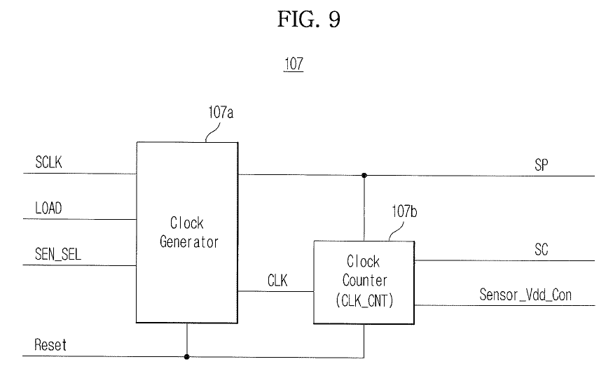

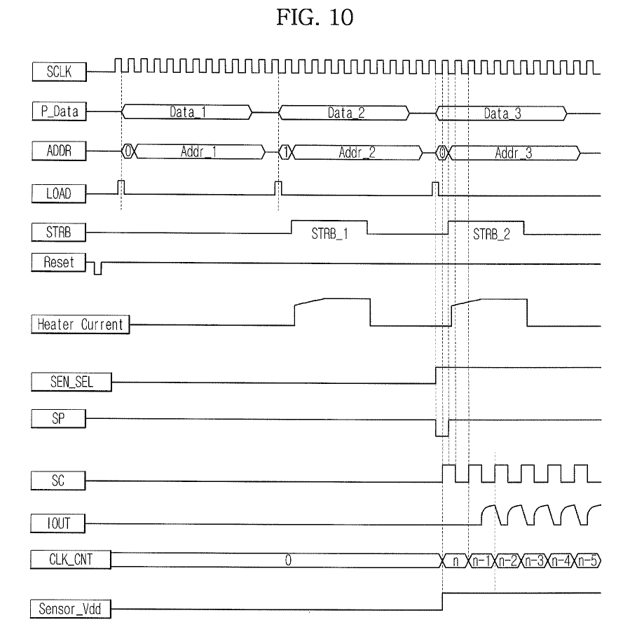

FIG. 8 illustrates in detail the constitution of the logic circuit unit 51 provided on the inkjet print head 20 according to the embodiment of the present general inventive concept. The logic circuit unit 51 generates heater control signals and photo sensor control signals using series data transmitted from the main body of the image forming apparatus. FIG. 9 illustrates in detail the constitution of a function logic (or extra function logic of FIG. 8) to generate photo sensor control signals using series data transmitted from the main body of the image forming apparatus. FIG. 10 illustrates timing of various signals to drive the inkjet print head 20.

As illustrated in FIGS. 8 to 10, in order to simplify a system design, one or more data lines for primitive data P_Data and address data ADDR may be a data line for serial data signals to decrease signal lines between an external control unit and the inkjet print head 20. The primitive data P_Data and address data ADDR correspond to printing data to print data (image) by controlling the inkjet unit 20b of the inkjet print head 20.

The logic circuit unit 51 includes an m×n AND gate array 101, an m×n-bit transistor array 102, an m-bit shift register 103, an m-bit latch 104, an n-bit shift register 106, an n-bit latch 105, and a function logic 107. Here, the m×n AND gate array 101 is a block, which generates a driving signal, the m×n-bit transistor array 102 is a block to generate thermal elements, for example, heaters 34, the m-bit shift register 103 and the m-bit latch 104 are blocks to process the primitive data (P_data) to correspond to heaters 34 of each group of the nozzles 32, the n-bit shift register 106 and the n-bit latch 105 are blocks to process the address data (ADDR) to select the each group of the nozzles 32, and the function logic 107 is a block to generate a signal to drive the photo sensors 54 using printing data transmitted from the main body of a printer (image forming apparatus) to the inkjet print head 20 to drive the heaters 34, and thus controls the photo sensors 54.

A reset signal (RESET) is applied to the shift registers 103 and 106 and the latches 104 and 105. Thereafter, the shift registers 103 and 106 respectively receive primitive data (P_data) and address data (ADDR) synchronizing with a serial clock signal (SCLK) in order to select the nozzle corresponding to the heater.

When a load signal (LOAD) is inputted to the latches 104 and 105, the latches 104 and 105 latch the primitive data (P_data) and the address data (ADDR) respectively supplied from the shift registers 103 and 106.

The function logic 107 includes a clock generator 107a and a clock counter 107b. The clock generator 107a receives a SEN-SEL signal generated from the address data (ADDR) to select any one of the plurality of the photo sensors 54, the serial clock signal (SCLK), and the load signal (LOAD), generates a shift start pulse (SP), and supplies to the serial clock signal (SCLK) to the clock counter 107b. The clock counter 107b receives the clock signal (CLK) and the shift start pulse (SP) synchronizing with the serial clock signal (SCLK), generates a Sensor_Vdd_Con signal to supply a power (Vdd) to the photo sensors 54 and the photo sensor control logic unit 53, and outputs the shift clock (SC) until a count value becomes zero.

When a strobe pulse (STRB) to discharge ink is inputted to the logic circuit unit 51, the strobe pulse (STRB) passes through the latched signals and the AND gates and turns on the transistor 102 of the corresponding nozzle, and applies a driving voltage (Vph) to the thermal element serving as the corresponding heater such that current flows into the thermal element, thus discharging the collected ink to the ink channel. Here, the reset signal (RESET) is used to initialize the respective data processing units and the shift registers.

The respective data are latched in the AND gates, only when the load signal (LOAD) is inputted to the logic circuit unit 51. Nozzles spraying ink according to a first strobe pulse (STRB_1) are nozzles corresponding to the first data (DATA_1), and nozzles spraying ink according to a second strobe pulse (STRB_2) are nozzles corresponding to the second data (DATA_2).

The strobe pulse (STRB) is a heater control signal, and is formed by counting internal counters as many as the number of the SLCK signals, which have been inputted in advance through series data ports, in synchronization with the serial clock (SCLK) and the load signal (LOAD).

The serial clock (SCLK), which is a clock synchronizing with series data (serial data), is continuously inputted, and a first bit of the address data (ADDR) is set to a photo sensor enable bit, and other bits the address data (ADDR) are set to address data (ADDR) bits the same as those of a conventional logic circuit unit. When the address data (ADDR) signal and the primitive data (P_data) signal are inputted, the load signal (LOAD), which is a data latch signal, is inputted in synchronization with the serial clock signal (SCLK) and is latched in the primitive data (P_data) and address data (ADDR) latches 104 and 105.

If a first bit of the address data (ADDR) is in an enable state, a SEN-SEL signal is generated according to the first bit thereof at the latching moment, and transmits the SEN-SEL signal to the clock generator 107a. The clock generator 107a synchronizes the SEN-SEL signal with the serial clock signal (SCLK) and the load signal (LOAD) and generates a shift start pulse (SP), and bypasses the serial clock signal (SCLK) and transmits the serial clock signal (SCLK) to the clock counter 107b using a CLK signal line. The clock counter 107b receives the clock signal (CLK) and the shift start pulse (SP) and generates a Sensor_Vdd_Con signal to supply a power (Vdd) to the photo sensors 54 and the photo sensor control logic unit 53, resets a count value to the number (n) of the sensors and decreases the count value whenever the clock signal (CLK) is inputted, and transmits the clock signal (CLK) as the shift clock (SC) until the count value becomes zero, thus sequentially outputting data from the respective photo sensors 54, as output values (IOUTs), as illustrated in FIG. 5. When the count value becomes zero, the output of the shift clock (SC) is stopped, and the Sensor_Vdd_Con signal becomes in a disable state so as to block the power (voltage) Vdd supplied to the photo sensors 54 and the photo sensor control logic unit 53, thereby preventing the shortening of a life span of the photo sensors 54 when the power is continuously supplied for a long time. Here, the SEN-SEL signal, the shift start pulse (SP) signal, the shift clock (SC) signal, the Sensor_Vdd_Con signal, etc., are photo sensor control signals.

According to the present general inventive concept, an inkjet print head includes photo sensors to sense defects in ink discharge of the nozzles discharging ink, and thus senses missing nozzles, whenever the ink is printed on a recording paper, to rapidly and correctly sense the missing nozzles, and an inkjet image forming apparatus having the inkjet print head.

According to the present general inventive concept, it is possible to rapidly and correctly sense the missing nozzles, and thus to directly compensate for an image defect, caused by the missing nozzles, using the sensed result through various image quality compensation method.

Although embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An inkjet print head comprising:
nozzle lines provided on a substrate to discharge ink; and
a plurality of photo sensors provided on the substrate, and separated from the nozzle lines at a designated distance to sense whether or not respective nozzles of the nozzle lines normally discharge the ink.

2. The inkjet print head of claim 1, wherein the photo sensors are disposed at an interval of the horizontal pitch between the nozzles of the nozzle lines according to resolution between the nozzles.

3. The inkjet print head of claim 1, wherein the photo sensors are mounted on the substrate.

4. The inkjet print head of claim 3, wherein the photo sensors are CMOS photo sensors.

5. The inkjet print head of claim 4, wherein each of the CMOS photo sensors includes N+ and P+ photoelectric elements, obtained by doping a substrate with impurities at a high concentration by a semiconductor doping process, and P and N semiconductor wells surrounding the photoelectric elements to minimize an electrical effect applied from the outside.

6. The inkjet print head of claim 1, further comprising:
a photo sensor control logic unit provided on the substrate to sequentially output the output values of the photo sensors.

7. The inkjet print head of claim 1, further comprising:
a plurality of heaters provided on a substrate to heat ink; and
logic circuit units provided on the substrate to generate heater control signals to control the plurality of heaters from printing data transmitted from a printer main body to drive the heaters and thus to control the operation of the respective heaters, and to generate photo sensor control signals to sequentially output the output values of the photo sensors from the printing data and thus to control the operation of the respective photo sensors.

8. The inkjet print head of claim 7, further comprising:
a photo sensor control logic unit provided on the substrate to sequentially output the output values of the photo sensors according to the photo sensor control signals.

9. The inkjet print head of claim 8, wherein the logic circuit units cut off power supplied to the plurality of the photo sensors and the photo sensor control logic unit, when all the output values of the photo sensors have been sequentially outputted.

10. An inkjet image forming apparatus comprising:
an inkjet print head including nozzle lines provided on a substrate to discharge ink, a plurality of photo sensors provided on the substrate, and separated from the nozzle lines at a designated distance to sense whether or not respective nozzles of the nozzle lines normally discharge the ink, and a photo sensor control logic unit provided on the substrate to sequentially output the output values of the photo sensors;
a light source disposed adjacent to the plurality of photo sensors to generate light such that the light is reflected by a recording paper and flows into the plurality of photo sensors; and
an ink cartridge main body mounting the inkjet print head and the light source thereon, and moving along the recording paper.

11. The inkjet image forming apparatus of claim 10, wherein the photo sensors are disposed at an interval of the horizontal pitch between the nozzles of the nozzle lines according to resolution between the nozzles.

12. The inkjet image forming apparatus of claim 10, wherein the photo sensors are CMOS photo sensors, each of which includes N+ and P+ photoelectric elements, obtained by doping a substrate with impurities at a high concentration by a semiconductor doping process, and P and N semiconductor wells surrounding the photoelectric elements to minimize an electrical effect applied from the outside.

13. An inkjet image forming apparatus comprising:
an inkjet print head including nozzle lines provided on a substrate to discharge ink, a plurality of photo sensors provided on the substrate, and separated from the nozzle lines at a designated distance to sense whether or not respective nozzles normally discharge the ink, and a photo sensor control logic unit provided on the substrate to sequentially output the output values of the photo sensors according to the photo sensor control signal;
a light source disposed adjacent to the plurality of photo sensors to generate light such that the light is reflected by a recording paper and flows into the plurality of photo sensors; and
a control unit to drive the light source when the inkjet print head moves along the recording paper and determine whether or not the nozzle lines have missing nozzles according to the output values sequentially outputted from the plurality of photo sensors.
